(19) United States
(12) Patent Application Publication
(10) Pub. No.: US 2003/0138661 A1
(43) Pub. Date: Jul. 24, 2003

(54) Sol-gel composition and method of making same

(75) Inventors: Thierry Souchard, Ville-sur-Saulx (FR); Jerome Reynes, Bettancourt-la-Ferree (FR); Jean-Christophe Eckmann, Saint-Dizier (FR)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: Ferro Corporation, Cleveland, OH

(21) Appl. No.: 10/369,381

(22) Filed: Feb. 19, 2003

(51) Int. Cl. B32B 9/00

(52) U.S. Cl. 428/689

(57) ABSTRACT

The present invention provides an article of cookware bearing a thermally cured sol-gel coating that is transparent, adherent, and exhibits excellent durability and chemical resistance. Preferably, the sol-gel coating composition, which includes a colloidal suspension of hydrolyzed metal alkoxide particles in an organic solvent, is applied to bare metal such as aluminum and its alloys or to porcelain enameled metals or other substrates using a conventional wet application technique such as spraying. The sol-gel coating composition is then thermally cured at a temperature below about 500° C. to provide a durable transparent inorganic polymer coating that exhibits excellent physical and chemical resistance. The present invention also provides a method of making such an article of cookware.

### BACKGROUND OF THE INVENTION

1. Field of Invention

The present invention relates to an article of cookware bearing a protective inorganic polymer coating. More particularly, the present invention provides an article of cookware bearing a thermally cured sol-gel coating that is transparent, adherent, and exhibits excellent durability and chemical resistance.

2. Description of Related Art

Bare aluminum, either brushed or polished, is aesthetically appealing, particularly in applications such as cookware. Unfortunately, however, the appearance of bare polished aluminum has a tendency to become degraded upon repeated exposure to food soils and dishwashing media. For this reason, aluminum cookware is often enameled. The porcelain enamel coating provides an attractive coating that is more durable than bare polished aluminum and is less prone to staining and degradation from dishwashing.

Unfortunately, enamels for use on aluminum tend to exhibit a lower chemical resistance than enamels for use on steel. The lowered chemical resistance of enamels for use on aluminum can be attributed to the need to include additional flux materials in the enamel composition to ensure that the enamel will soften at a lower firing temperature. For this reason, porcelain enameled aluminum frying pans tend to exhibit a reduced resistance to food soils and repeated dishwashing than porcelain enameled steel frying pans. Bake-on foods such as ketchup, wine and mustard also have a tendency to irreversibly stain enameled aluminum substrates and repeated dishwashing cycles tend to make the enameled surface dull and matte. This is particularly true for enamel formulations that contain sparkling pigments.

In view of the inherent difficulties in improving the chemical resistance of porcelain enamels for aluminum substrates, efforts have been undertaken to develop alternative surface coatings and/or treatments for aluminum substrates. Unfortunately, most known coatings are not suitable for application onto aluminum for various reasons. For example, high temperature paints do not have the aesthetic appearance of porcelain enamels (gloss, color strength) nor the mechanical properties (bond to the metal, hardness). The same limitations apply to polytetrafluoroethylene (PTFE) based coatings. Other surface coatings and/or treatments require too high of a curing temperature (e.g., greater than about 500° C.) for use on aluminum, and they can induce visible cracks on the finished articles. Moreover, other coatings have too little hardness.

A coating is needed that can be applied to aluminum substrates, including bare polished or brushed aluminum substrates, anodized aluminum substrates and porcelain enameled aluminum substrates. The coating should provide excellent chemical resistance and resistance to food soils and dishwashing. The coating should exhibit good surface hardness. Preferably, the coating provides a transparent layer that preserves the aspects of the underlying aluminum or enamel substrate. In addition, such a coating should be curable using existing industrial equipment.

### BRIEF SUMMARY OF THE INVENTION

The present invention provides an article of cookware that overcomes the limitations and disadvantages of prior art and provides improved use properties. In accordance with the invention, an article of cookware is provided on at least one surface with an adherent, transparent, durable and chemically resistant cured sol-gel coating layer having a thickness preferably less than about 10 μm and more preferably less than about 3 μm. The coating can be applied to one or more surfaces of a variety of articles of cookware such as, for example, pans, pots, frying pans, and molds. Furthermore, in addition to bare polished or brushed aluminum and anodized aluminum, the coating can be applied to a variety of metals such as steel, stainless steel and cast iron. The coating can be applied over bare metal substrates or over metal that has been previously coated with a porcelain enamel coating. The coating can also be applied to ceramic substrates.

An article of cookware according to the present invention is preferably formed of aluminum (the term “aluminum” as used throughout the instant specification and in the appended claims refers to pure aluminum and alloys of aluminum unless otherwise clearly stated) and has a cured transparent sol-gel coating on at least one surface thereof. The cured sol-gel coating is durable and exhibits excellent chemical resistance. Optionally, the article of cookware can further be provided on a food-contacting surface with an anti-adherent coating such polytetrafluoroethylene (PTFE)-based coatings. Both the PTFE and sol-gel coatings can be cured at the same time using the same equipment.

In a preferred embodiment of the invention, the article of cookware is formed of aluminum and has a porcelain enamel coating applied to at least one surface. The porcelain enamel coating can be of any color. The durable transparent sol-gel coating is then applied over the porcelain enamel coating. Optionally, the food-contacting surface of the cooking article is coated with an anti-adherent PTFE-based coating. According to yet another embodiment, the inside and/or outside of the aluminum cookware article is anodized.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

The present invention provides an article of cookware bearing a protective coating on at least one surface, which is preferably an external surface. The protective coating is a sol-gel coating that is cured at a temperature below about 500° C. to provide an adherent transparent coating that exhibits excellent durability and chemical resistance. The sol-gel coating can be applied directly to metal surfaces such as aluminum, steel, stainless steel and cast iron. Alternatively, the sol-gel coating can be applied to fired porcelain enamel surfaces.

The sol-gel coating can be applied using conventional wet application process such as, for example, dipping and spraying. During thermal curing, the sol-gel coating firmly bonds to the substrate to which it is applied, and after curing exhibits excellent adhesion. Preferably, the cured sol-gel coating layer has a maximum thickness of about 10 μm. More preferably, the thickness of the cured sol-gel coating layer is less than about 1 μm. The cured sol-gel coating layer exhibits excellent durability including good scratch resistance.

The sol-gel coating is formed of inorganic polymers that provide good corrosion resistance, protection from staining and attack by baked-on foods, and degradation due to frequent dishwashing exposure. Such inorganic polymers can be based on poly-zirconium oxides, poly-titanium oxides and/or poly-aluminum oxides. However, in view of cost, use is preferably made of inorganic polymers based on poly-silicon oxides (polysilicates). Sol-gels on the basis of polysilicates, which can be manufactured using well-known procedures, remain stable for a longer period of time than the other above-mentioned sols. By means of the sol-gel process, very thin layers of inorganic polymer can be provided on substrates such as metals and porcelain enamels. For example, thicknesses below about 1 μm can be obtained by using this technique.

The preparation of sol-gel coating solutions used in the invention is conventional. As is known by those having ordinary skill in the art of preparing sols, initially a colloidal suspension of solid particles in a liquid is prepared. For purposes of the present invention, it is preferable to form a colloidal suspension of hydrolyzed metal alkoxide particles in an organic solvent. A substantial variety of hydrolyzed metal alkoxides of titanium, zirconium, aluminum and/or silicon are commercially available. Usually, an alcohol is used as the organic solvent. A small quantity of water and a small quantity of an acid or a base, which functions as a catalyst depending upon the metal alkoxide selected, is then added to the colloidal solution (or sol), which is then applied to the substrate using a conventional wet application technique. The catalyst and the added water bring about the hydrolysis of the alkoxides, which after polycondensation during thermal curing at a temperature below about 500° C. causes the formation of an inorganic polymer.

By means of the sol-gel process, very thin layers of inorganic polymer can be provided on the cooking article. For example, thickness below 3 μm and even below 1 μm can be obtained by using this technique. The cost of applying the sol-gel coating to articles of cookware can be reduced by the use of thin layers and the choice of an alkoxy silicate as monomer for the inorganic polymer.

As mentioned above, a variety of application techniques can be used to apply the colloidal solution to substrates including, for example, spraying, dipping and spin coating. The presently most preferred method of applying the sol-gel coating is by spraying.

After the sol-gel coating composition is applied to a substrate, it is preferably dried prior to curing. The means employed to dry the coating is not per se critical, and a variety of means can be used. For example, the coating can be dried on a substrate by placing the substrate in an oven heated to about 80° C. for about 1 hour. It is also possible to dry the coating by passing the coated substrate through a continuous infrared (IR) lamp dryer for about 6 minutes at 60° C. Partial drying is acceptable.

Drying extracts the solvent from the sol-gel coating composition, which results in the formation a solid coating. The solid coating is then hardened by firing at a temperature between about 250° C. and 500° C., and more preferably between about 350° C. and 450° C. When applied to porcelain enamel substrates, the sol-gel coating is preferably fired at a temperature of between about 350° C. and 420° C.

The firing time is not per se critical, and a range of firing times can be used. Typically, the coating is cured during a firing schedule of from between 10 minutes and 1 hour. The coating can be cured in a conventional industrial continuous furnace such as is used to apply PTFE coatings using a conventional firing schedule (e.g., 30 minutes at 400° C. and 7-10 minutes at 420° C.). Thus, the coating composition can be cured at the same time with PTFE coated articles using the same equipment.

The cured coating forms a transparent protective layer on the surface of the substrate. The cured coating exhibits excellent chemical resistance, and is resistant to staining and degradation caused by frequent exposure to dishwashing media. Accordingly, the coating is particularly suitable for use in cookware applications, such as on bare polished aluminum substrates or on porcelain enameled aluminum substrates. The coating also provides protection against hot water and water vapor, which makes it suitable for use on water heaters. Moreover, the coating reduces the markings that can be caused by fingerprints.

The sol-gel coating composition according to the invention can be applied to a variety of substrates including, for example, metals (e.g., aluminum, steel, aluminized steel, copper, brass, bronze, and tin), enameled metals, glass, and ceramic. Because the sol-gel coating composition according to the invention can be fully cured at a relatively low temperature (e.g., below about 500° C.), it is particularly suitable for application to bare polished aluminum and porcelain enameled aluminum. When cured, the sol-gel coating composition forms a transparent protective coating that permits the appealing aspects of the underlying layer (e.g., color, reflectivity) to show through.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. An article of cookware comprising:
a substrate having a desired shape; and
an inorganic polymer coating disposed on the substrate, the inorganic polymer being formed by applying a sol-gel composition comprising colloidal suspension of hydrolyzed metal alkoxide particles in an organic solvent to the substrate using a wet application technique and thermally curing the applied sol-gel composition at a temperature below about 500° C.

2. The article of cookware according to claim 1 wherein the substrate comprises a material selected from the group consisting of metal, porcelain enamel, ceramic and glass.

3. The article of cookware according to claim 2 wherein the metal is selected from the group consisting of aluminum, steel, aluminized steel, copper, brass, bronze, and tin.

4. The article of cookware according to claim 1 wherein the inorganic polymer coating has a thickness of less than about 10 μm.

5. A method of forming an article of cookware comprising:
providing a substrate having a desired shape;
applying a sol-gel composition comprising a colloidal suspension of hydrolyzed metal alkoxide particles in an organic solvent to the substrate using a wet application technique; and
thermally curing the applied sol-gel composition at a temperature below about 500° C. to form an inorganic polymer coating disposed on the substrate.

6. The method according to claim 5 wherein the sol-gel composition is applied to the substrate by spraying, dip coating or spin coating.

7. The method according to claim 6 wherein the sol-gel composition is dried on the substrate prior to thermal curing.

8. The method according to claim 5 wherein the substrate comprises a material selected from the group consisting of metal, porcelain enamel, ceramic and glass.

9. The method according to claim 8 wherein the metal is selected from the group consisting of aluminum, steel, aluminized steel, copper, brass, bronze, and tin.

10. The method according to claim 5 wherein the inorganic polymer coating has a thickness of less than about 10 μm.

11. The method according to claim 5 wherein:
the substrate has an internal surface and an external surface;
a thermally curable anti-adherent PTFE-based coating material is applied to the internal surface;
the sol-gel composition is applied to the external surface; and
the anti-adherent PTFE-based coating material and the sol-gel composition are thermally cured at the same time.
